(19) United States
(12) Patent Application Publication
(10) Pub. No.: US 2025/0331047 A1
(43) Pub. Date: Oct. 23, 2025

(54) RADIO COMMUNICATION APPARATUS

(71) Applicant: Sharp Kabushiki Kaisha, Sakai City (JP)

(72) Inventors: Atsushi SHIRAKAWA, Sakai City (JP); Hiromichi TOMEBA, Sakai City (JP); Hideo NAMBA, Sakai City (JP); Yasuhiro HAMAGUCHI, Sakai City (JP)

(21) Appl. No.: 19/254,360

(22) Filed: Jun. 30, 2025

Related U.S. Application Data
(63) Continuation of application No. 18/007,759, filed on Dec. 2, 2022.

(30) Foreign Application Priority Data
Jun. 3, 2020 (JP) 2020-096549

(51) Int. Cl. H04W 76/15

(52) U.S. Cl. CPC H04W 76/15

(57) ABSTRACT

A radio communication apparatus includes a transmitter configured to transmit a first management frame, and a receiver configured to receive a second management fame as a response to the first management frame. The first management frame includes first information indicating either a first operation mode or a second operation mode as a multi-link operation mode, the first management frame also including second information indicating a first link used by the station apparatus in the multi-link operation mode, the first link being one of the multiple links. The first operation mode is the multi-link operation mode in which the station apparatus transmits or receives frames on one of the multiple links. The station apparatus operates in the first operation mode after the receiver receives the second management frame.

### TECHNICAL FIELD

The present invention relates to a radio communication apparatus.

This application is a Continuation of U.S. application Ser. No. 18/007,759, filed on Dec. 2, 2022, which is a 371 National Stage of PCT/JP2021/019906, filed on May 26, 2021, which claims foreign priority to Japanese Patent Application No. 2020-096549, filed on Jun. 3, 2020, the entire contents of which are incorporated herein by reference.

### BACKGROUND ART

The Institute of Electrical and Electronics Engineers Inc. (IEEE) is in the process of standardizing IEEE 802.11ax to achieve higher speed than IEEE 802.11 which is a wireless Local Area Network (LAN) standard, and wireless LAN devices compliant with the draft specification are available in the market. The standardization of IEEE 802.11be, which is a standard subsequent to IEEE 802.11ax, has been recently started. As the wireless LAN devices are rapidly widely used, in the standardization of IEEE 802.11be, studies have been in progress to further improve throughput per user in environments where the wireless LAN devices are densely installed.

The wireless LAN allows a frame transmission to be performed using unlicensed bands in which radio communication can be performed without permission (license) by nations or regions. The unlicensed bands currently widely used include a 2.4 GHz band and a 5 GHz band. The 2.4 GHz band has a relatively wide coverage, but largely suffers from interference between communication apparatuses and does not have a wide communication bandwidth. On the other hand, the 5 GHz band has a wide communication band, but does not have a wide coverage. Accordingly, to achieve various service applications on the wireless LAN, frequency bands to be used need to be switched appropriately. However, the existing wireless LAN apparatuses need to terminate the current connection once in order to switch the frequency band used for communication.

Therefore, in the IEEE 802.11be standardization, a Multi-link Operation (MLO) that enables a communication apparatus to maintain multiple connections (links) has been discussed (see NPL 1). According to the MLO, the communication apparatus can maintain multiple connections each of which has a different configuration for radio resources to be used and communications. In other words, by use of the MLO, the communication apparatus can simultaneously maintain the connections in different frequency bands, and thus, can change the frequency band to transmit the frame without performing a reconnection operation.

### CITATION LIST

### Non Patent Literature

NPL 1: IEEE 802.11-20/0115-04-Obe, January 2020

### SUMMARY OF INVENTION

### Technical Problem

However, there are various use cases that applies the MLO. Some use cases may transmit and/or receive a frame on multiple connections at any time, or some use cases may maintain multiple connections and transmit and/or receive a frame actually only on some connections of the multiple connections. In some use cases, once a transmission opportunity for frame transmission is obtained, continuous frame transmission may be desired as much as possible, or only intermittent transmission of a small number of frames may be necessary. In order to implement an efficient MLO, it is necessary to define a framework and procedure to support such various use cases.

The present invention has been made in view of the problems described above, and an object of the present invention is to disclose an access point apparatus and a station apparatus that efficiently implements MLO in a wireless LAN system that applies MLO to various use cases.

### Solution to Problem

A radio communication apparatus according to the present invention for solving the aforementioned problem are as follows.

Specifically, a radio communication apparatus according to an aspect of the present invention includes a transmitter configured to transmit a first management frame, and a receiver configured to receive a second management fame as a response to the first management frame. The first management frame includes first information indicating either a first operation mode or a second operation mode as a multi-link operation mode, the first management frame also including second information indicating a first link used by the station apparatus in the multi-link operation mode, the first link being one of the multiple links. The first operation mode is the multi-link operation mode in which the station apparatus transmits or receives frames on one of the multiple links. The station apparatus operates in the first operation mode after the receiver receives the second management frame.

The station apparatus operates in the first operation mode, after the receiver receives the second management frame, in a case where the second management indicates that the station apparatus is allowed to operate in the first operation mode.

Before the transmitter transmits the first management frame, the transmitter transmits a third management frame, and the receiver receives a fourth management frame as a response to the third management frame and then establishes a multi-link connection using the multiple links with the access point apparatus.

The first management frame is different from the third management frame and the second management frame is different from the fourth management frame.

### Advantageous Effects of Invention

According to the present invention, by providing the method for configuring the operation mode in a multi-link establishment request procedure or a multi-link change request procedure, multi-link operation depending on a use case can be performed to improve the efficiency.

### BRIEF DESCRIPTION OF DRAWINGS

FIG. 1 is a diagram illustrating an example of a frame configuration according to an aspect of the present invention.

FIG. 2 is a diagram illustrating an example of the frame configuration according to an aspect of the present invention.

FIG. 3 is a diagram illustrating an example of communication according to an aspect of the present invention.

FIG. 4 is an overview diagram illustrating examples of splitting a radio medium according to an aspect of the present invention.

FIG. 5 is a diagram illustrating a configuration example of a communication system according to an aspect of the present invention.

FIG. 6 is a block diagram illustrating a configuration example of a radio communication apparatus according to an aspect of the present invention.

FIG. 7 is a block diagram illustrating a configuration example of a radio communication apparatus according to an aspect of the present invention.

FIG. 8 is an overview diagram illustrating an example of a coding scheme according to an aspect of the present invention.

FIG. 9 is an overview diagram illustrating an example of a coding scheme according to an aspect of the present invention.

FIG. 10 is an overview diagram illustrating communication according to an aspect of the present invention.

FIG. 11 is an overview diagram illustrating communication according to an aspect of the present invention.

FIG. 12 is an overview diagram illustrating communication according to an aspect of the present invention.

FIG. 13 is an overview diagram illustrating communication according to an aspect of the present invention.

### DESCRIPTION OF EMBODIMENTS

A communication system according to the present embodiment includes a radio transmitting apparatus (access point apparatus, base station apparatus: access point, base station apparatus) and multiple radio receiving apparatuses (station apparatuses, terminal apparatuses: stations, terminal apparatuses). A network including the base station apparatus and the terminal apparatuses is referred to as a basic service set (BSS, management range). The station apparatus according to the present embodiment can include function of the access point apparatus. Similarly, the access point apparatus according to the present embodiment can include function of the station apparatus. Therefore, in a case that a communication apparatus is simply mentioned below, the communication apparatus can indicate both the station apparatus and the access point apparatus.

The base station apparatus and the terminal apparatuses in the BSS are assumed to perform communication based on Carrier sense multiple access with collision avoidance (CSMA/CA). Although an infrastructure mode in which the base station apparatus performs communication with the multiple terminal apparatuses is targeted in the present embodiment, the method of the present embodiment can also be performed in an ad hoc mode in which the terminal apparatuses perform communication directly with each other. In the ad hoc mode, the terminal apparatus forms the BSS instead of the base station apparatus. The BSS in the ad hoc mode is also referred to as an Independent Basic Service Set (IBSS). In the following description, a terminal apparatus that forms the IBSS in the ad hoc mode can also be considered to be a base station apparatus. The method of the present embodiment can also be implemented in Wi-Fi Direct (trade name) in which the terminal apparatuses directly communicate with each other. In Wi-Fi Direct, the terminal apparatus forms a Group instead of the base station apparatus. In the following description, a Group owner terminal apparatus that forms a Group in Wi-Fi Direct can also be considered to be a base station apparatus.

In an IEEE 802.11 system, each apparatus can transmit transmission frames of multiple frame types with a common frame format. Each transmission frame is defined by a physical (PHY) layer, a Medium Access Control (MAC) layer, and a Logical Link Control (LLC) layer.

A transmission frame of the PHY layer is referred to as a physical protocol data unit (PPDU: PHY protocol data unit or physical layer frame). The PPDU includes a physical layer header (PHY header) including header information and the like for performing signal processing in the physical layer, a physical service data unit (PSDU: PHY service data unit or MAC layer frame) that is a data unit processed in the physical layer, and the like. The PSDU can include an Aggregated MAC protocol data unit (A-MPDU) in which multiple MPDUs as a retransmission unit in a radio section are aggregated.

The PHY header includes reference signals such as a Short training field (STF) used for detection, synchronization, and the like of signals and a Long training field (LTF) used for obtaining channel information for demodulating data, and a control signal such as a Signal (SIG) including control information for demodulating data. The STF is classified into a Legacy-STF (L-STF), a High throughput-STF (HT-STF), a Very high throughput-STF (VHT-STF), a High efficiency-STF (HE-STF), an Extremely High Throughput-STF (EHT-STF), and the like in accordance with compliant standards, and the LTF and the SIG are also similarly classified into the L-LTF, the HT-LTF, the VHT-LTF, the HE-LTF, the L-SIG, the HT-SIG, the VHT-SIG, the HE-SIG, and the EHT-SIG. The VHT-SIG is further classified into VHT-SIG-A1, VHT-SIG-A2, and VHT-SIG-B. Similarly, the HE-SIG is classified into HE-SIG-A1 to 4 and HE-SIG-B. On the assumption of updating of technologies in the same standard, a Universal SIGNAL (U-SIG) field including additional control information can be included.

Furthermore, the PHY header can include information for identifying a BSS of a transmission source of the transmission frame (hereinafter, also referred to as BSS identification information). The information for identifying the BSS can be, for example, a Service Set Identifier (SSID) of the BSS or a MAC address of a base station apparatus of the BSS. The information for identifying the BSS can be a value unique to the BSS (such as a BSS color, for example) other than the SSID and the MAC address.

The PPDU is modulated in accordance with the compliant standard. In IEEE 802.11n standards, for example, the PPDU is modulated into an orthogonal frequency division multiplexing (OFDM) signal.

The MPDU includes a MAC layer header (MAC header) including header information and the like for performing signal processing in the MAC layer, a MAC service data unit (MSDU) that is a data unit processed in the MAC layer or a frame body, and a Frame check sequence (FCS) for checking whether there is an error in the frame. The multiple MSDUs can be aggregated as an Aggregated MSDU (A-MSDU).

The frame types of transmission frames of the MAC layer are roughly classified into three frame types, namely a management frame for managing a connection state and the like between apparatuses, a control frame for managing a communication state between apparatuses, and a data frame including actual transmission data, and each frame type is further classified into multiple kinds of subframe types. The control frame includes a reception completion notification (Acknowledge (Ack)) frame, a Request to send (RTS) frame, a reception preparation completion (Clear to send (CTS)) frame, and the like. The management frame includes a Beacon frame, a Probe request frame, a Probe response frame, an Authentication frame, a connectivity (Association) request frame, a connectivity (Association) response frame, and the like. The data frame includes a Data frame, a polling (CF-poll) frame, and the like. Each apparatus can recognize a frame type and a subframe type of a received frame by reading detail of the frame control field included in a MAC header.

Note that Ack may include Block Ack. Block Ack can perform a reception completion notification to multiple MPDUs.

The beacon frame includes a Field in which an interval at which a beacon is transmitted (Beacon interval) and an SSID are stated. The base station apparatus can periodically broadcast the BSS of the beacon frame, and each terminal apparatus can recognize the base station apparatus in the surroundings of the terminal apparatus by receiving the beacon frame. The action of the terminal apparatus recognizing the base station apparatus based on the beacon frame broadcast from the base station apparatus is referred to as Passive scanning. On the other hand, an action of the terminal apparatus searching for the base station apparatus by broadcasting a probe request frame in the BSS is referred to as Active scanning. The base station apparatus can transmit a probe response frame as a response to the probe request frame, and detail stated in the probe response frame is equivalent to that in the beacon frame.

The terminal apparatus recognizes the base station apparatus and performs processing to establish connection with the base station apparatus. The connection processing is classified into an Authentication procedure and a connection (Association) procedure. The terminal apparatus transmits an authentication frame (authentication request) to the base station apparatus with which connection is desired. Once the base station apparatus receives the authentication frame, then the base station apparatus transmits, to the terminal apparatus, an authentication frame (authentication response) including a status code indicating whether authentication can be made for the terminal apparatus. The terminal apparatus can determine whether the terminal apparatus has been authenticated by the base station apparatus by reading the status code stated in the authentication frame. Note that the base station apparatus and the terminal apparatus can exchange the authentication frame multiple times.

After the authentication procedure, the terminal apparatus transmits a connectivity request frame to the base station apparatus in order to perform the connection procedure. Once the base station apparatus receives the connectivity request frame, the base station apparatus determines whether to allow the connection of the terminal apparatus and transmits a connectivity response frame to provide a notification regarding the determination. In the connectivity response frame, an association identification number (Association identifier (AID)) for identifying the terminal apparatus is stated in addition to a status code indicating whether to perform the connection processing. The base station apparatus can manage multiple terminal apparatuses by configuring different AIDs for the terminal apparatuses for which the base station apparatus has allowed connection.

After the connection processing is performed, the base station apparatus and the terminal apparatus perform actual data transmission. In the IEEE 802.11 system, a Distributed Coordination Function (DCF), a Point Coordination Function (PCF), and a function in which the DCF and the PCF are enhanced (an Enhanced distributed channel access (EDCA), a Hybrid coordination function (HCF), and the like) are defined. A case that the base station apparatus transmits signals to the terminal apparatus using the DCF will be described below as an example.

In the DCF, the base station apparatus and the terminal apparatus perform Carrier sense (CS) for checking a utilization condition of a radio channel in the surroundings of the apparatuses themselves prior to communication. For example, in a case that the base station apparatus being a transmitting station receives a signal in a level higher than a predefined Clear channel assessment level (CCA level) in the radio channel, transmission of the transmission frame through the radio channel is postponed. Hereinafter, a state in which a signal in a level equal to or higher than the CCA level is detected in the radio channel is referred to as a Busy state, and a state in which a signal in a level equal to or higher than the CCA level is not detected is referred to as an Idle state. In this manner, CS performed based on a power (reception power level) of a signal actually received by each apparatus is referred to as physical carrier sense (physical CS). Note that the CCA level is also referred to as a carrier sense level (CS level) or a CCA threshold (CCAT). Note that in a case that a signal in a level equal to or higher than the CCA level is detected, the base station apparatus and the terminal apparatus start to perform an operation of demodulating at least a signal of the PHY layer.

The base station apparatus performs carrier sense corresponding to a frame interval (Inter frame space (IFS)) in accordance with the type of transmission frame to be transmitted and determines which of the busy state and the idle state the radio channel is in. The period during which the base station apparatus performs carrier sense differs depending on the frame type and the subframe type of transmission frame to be transmitted by the base station apparatus from now on. In the IEEE 802.11 system, multiple IFSs with different periods are defined, that are a short frame interval (Short IFS: SIFS) used for a transmission frame to which the highest priority is given, a polling frame interval (PCF IFS: PIFS) used for a transmission frame with relatively high priority, a distributed control frame interval (DCF IFS: DIFS) used for a transmission frame with the lowest priority, and the like. In a case that the base station apparatus transmits a data frame with the DCF, the base station apparatus uses the DIFS.

The base station apparatus waits for DIFS and then further waits for a random backoff time to prevent frame collision. In the IEEE 802.11 system, a random backoff time called a Contention window (CW) is used. CSMA/CA is based on the assumption that a transmission frame transmitted by a certain transmitting station is received by a receiving station in a state with no interference from other transmitting stations. Therefore, in a case that transmitting stations transmit transmission frames at the same timing, the frames collide against each other, and the receiving station cannot receive them properly. Thus, each transmitting station waits for a randomly configured time before starting the transmission, such that the collision of the frames is avoided. In a case that the base station apparatus determines, through carrier sense, that a radio channel is in an idle state, the base station apparatus starts counting-down of CW and acquires a transmission right for the first time after CW becomes zero, and thus can transmit the transmission frame to the terminal apparatus. Note that in a case that the base station apparatus determines through the carrier sense that the radio channel is in the busy state during the counting-down of CW, the base station apparatus stops the counting-down of CW. In a case that the radio channel is brought into the idle state, then the base station apparatus restarts the counting-down of the remaining CW after the previous IFS.

A terminal apparatus being a receiving station receives a transmission frame, reads a PHY header of the transmission frame, and demodulates the received transmission frame. Then, the terminal apparatus can recognize whether the transmission frame is destined to the terminal apparatus by reading a MAC header of the demodulated signal. Note that the terminal apparatus can also determine the destination of the transmission frame based on information stated in the PHY header (for example, a group identification number (Group identifier (Group ID: GID)) stated in the VHT-SIG-A).

In a case that the terminal apparatus determines the received transmission frame as destined to the terminal apparatus and succeeds in demodulation of the transmission frame without any error, the terminal apparatus has to transmit an ACK frame indicating that the frame has been properly received to the base station apparatus being the transmitting station. The ACK frame is one of transmission frames with the highest priority transmitted only after the waiting for the SIFS period (with no random backoff time). The base station apparatus ends the series of communication in response to reception of the ACK frame transmitted from the terminal apparatus. Note that in a case that the terminal apparatus has not been able to receive the frame properly, the terminal apparatus does not transmit ACK. Thus, the base station apparatus ends the communication on the assumption that the communication has been failed in a case that the ACK frame has not been received from the receiving station for a certain period (SIFS+ACK frame length) after the frame transmission. In this manner, end of a single communication (also called a burst) of the IEEE 802.11 system is always determined based on whether the ACK frame has been received except for special cases such as a case of transmission of a broadcast signal such as a beacon frame and a case that fragmentation for splitting transmission data is used.

In a case that the terminal apparatus determines that the received transmission frame is not destined to the terminal apparatus, the terminal apparatus configures a Network allocation vector (NAV) based on the Length of the transmission frame stated in the PHY header or the like. The terminal apparatus does not attempt communication during a period configured in the NAV. In other words, because the terminal apparatus performs the same operation as in a case that the physical CS determines that the radio channel is in the busy state for a period configured in the NAV, the communication control based on the NAV is also called virtual carrier sense (virtual CS). The NAV is also configured by a Request to send (RTS) frame and a reception preparation completion (Clear to send (CTS)) frame, which are introduced to solve a hidden terminal problem in addition to the case that the NAV is configured based on the information stated in the PHY header.

Compared to the DCF in which each apparatus performs carrier sense and autonomously acquires a transmission right, the PCF controls a transmission right of each apparatus inside the BSS using a control station called a Point coordinator (PC). In general, the base station apparatus serves as a PC and acquires a transmission right of the terminal apparatus inside the BSS.

A communication period using the PCF includes a Contention free period (CFP) and a Contention period (CP). During the CP, communication is performed based on the aforementioned DCF, and the PC controls the transmission right during the CFP. The base station apparatus being a PC broadcasts a beacon frame with description of a CFP period (CFP Max duration) and the like in the BSS prior to a communication using the PCF. Note that the PIFS is used to transmit the beacon frame broadcast at the time of a start of transmission using the PCF, and the beacon frame is transmitted without waiting for CW. The terminal apparatus that has received the beacon frame configures the period of CFP stated in the beacon frame to the NAV. Thereafter, the terminal apparatus can acquire the transmission right only in a case that a signal (a data frame including CF-poll, for example) that performs signaling an acquisition of a transmission right transmitted by the PC is received, until the NAV elapses or a signal (a data frame including CF-end, for example) that broadcasts the end of the CFP in the BSS is received. Note that, because no packet collision occurs inside the same BSS during the CFP period, each terminal apparatus does not take a random backoff time used in the DCF.

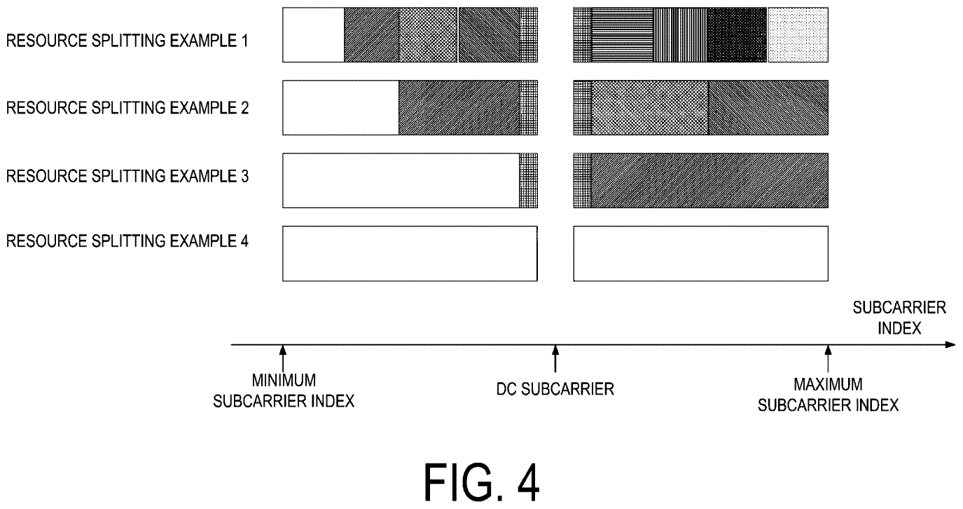

The radio medium can be split into multiple Resource units (RUs). FIG. 4 is an overview diagram illustrating an example of a split state of a radio medium. In the resource splitting example 1, for example, the radio communication apparatus can split a frequency resource (subcarrier) being a radio medium into nine RUs. Similarly, in the resource splitting example 2, the radio communication apparatus can split a subcarrier being a radio medium into five RUs. It is a matter of course that each resource splitting example illustrated in FIG. 4 is just an example, and for example, each of the multiple RUs can include a different number of subcarriers. The radio medium split into RUs can include not only a frequency resource but also a spatial resource. The radio communication apparatus (AP, for example) can transmit frames to multiple terminal apparatuses (multiple STAs, for example) at the same time by mapping each of the frames destined to different one of the multiple terminal apparatuses to the respective one of the RUs. The AP can state information indicating the split state of the radio medium (Resource allocation information) as common control information in the PHY header of the frame transmitted by the AP. Moreover, the AP can state information indicating a RU where a frame destined to each STA is mapped (resource unit assignment information) as unique control information in the PHY header of the frame the AP transmits.

The multiple terminal apparatuses (multiple STAs, for example) can transmit frames at the same time by transmitting each frame mapped to each RU allocated to each of the multiple terminal apparatuses. The multiple STAs can perform frame transmissions after waiting for a prescribed period after receiving the frame (Trigger frame: TF) including trigger information transmitted from the AP. Each STA can recognize the RU allocated to the STA based on the information stated in the TF. Each STA can acquire the RU through a random access with reference to the TF.

The AP can allocate multiple RUs to one STA at the same time. Each of the multiple RUs can include continuous subcarriers or can include non-continuous subcarriers. The AP can transmit one frame using multiple RUs allocated to one STA or can transmit multiple frames with the frames allocated to different RUs. At least one of the multiple frames can be a frame including common control information for multiple terminal apparatuses that transmit Resource allocation information.

One STA can be allocated with multiple RUs by the AP. The STA can transmit one frame using the multiple allocated RUs. The STA can use the multiple allocated RUs to perform transmission of multiple frames allocated to mutually different RUs. The multiple frames can be frames of mutually different frame types.

The AP can allocate multiple AIDs to one STA. The AP can allocate an RU to each of the multiple AIDs allocated to the one STA. The AP can transmit mutual different frames using each RU allocated to the respective one of the multiple AIDs allocated to the one STA. The different frames can be frames of mutually different frame types.

One STA can be allocated with multiple AIDs by the AP. For one STA, an RU can be allocated to each of the multiple allocated AIDs. One STA can recognize all of the RUs allocated to the multiple AIDs allocated to the STA as RUs allocated to the STA and can transmit one frame using the multiple allocated RUs. One STA can transmit multiple frames using the multiple allocated RUs. At this time, each of the multiple frames can be transmitted with information indicating an AID associated with the respective one of the allocated RUs stated therein. The AP can transmit mutual different frames using each of the RUs allocated to the respective one of the multiple AIDs allocated to the one STA. The different frames can be frames of different frame types.

Hereinafter, the base station apparatus and the terminal apparatuses will be collectively referred to as radio communication apparatuses or communication apparatuses. Information exchanged in a case that a certain radio communication apparatus performs communication with another radio communication apparatus will also be referred to as data. In other words, the radio communication apparatus includes the base station apparatus and the terminal apparatuses.

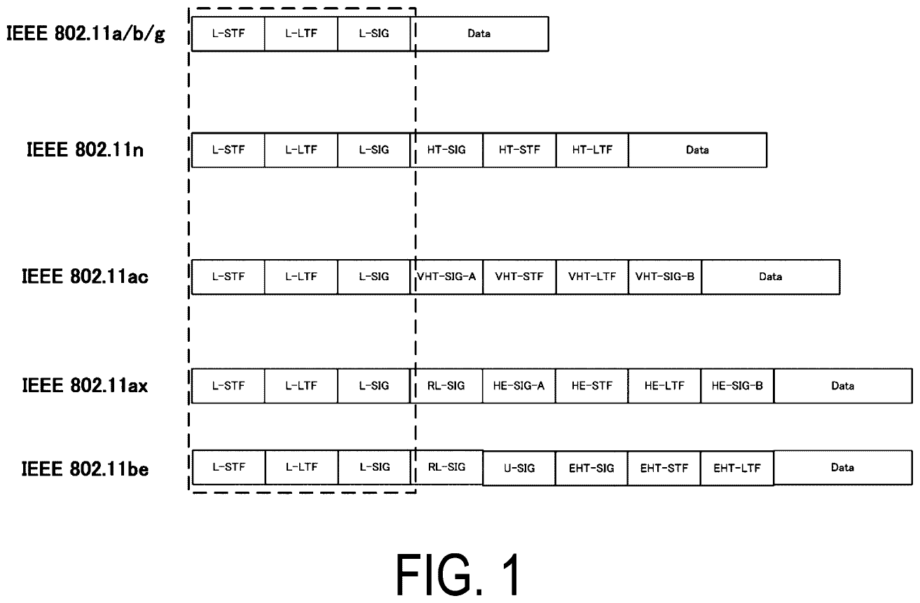

The radio communication apparatus includes either or both of a function of transmitting a PPDU and a function of receiving a PPDU. FIG. 1 is a diagram illustrating an example of a PPDU configuration transmitted by the radio communication apparatus. The PPDU that is compliant with the IEEE 802.11a/b/g standard includes L-STF, L-LTF, L-SIG, and a Data frame (a MAC Frame, a MAC frame, a payload, a data part, data, information bits, and the like). The PPDU that is compliant with the IEEE 802.11n standard includes L-STF, L-LTF, L-SIG, HT-SIG, HT-STF, HT-LTF, and a Data frame. The PPDU that is compliant with the IEEE 802.11ac standard includes some or all of L-STF, L-LTF, L-SIG, VHT-SIG-A, VHT-STF, VHT-LTF, VHT-SIG-B, and a MAC frame. The PPDU studied in the IEEE 802.11ax standard includes some or all of L-STF, L-LTF, L-SIG, RL-SIG in which L-SIG is temporally repeated, HE-SIG-A, HE-STF, HE-LTF, HE-SIG-B, and a Data frame. The PPDU studied in the IEEE 802.11bc standard includes some or all of L-STF, L-LTF, L-SIG, RL-SIG, U-SIG, EHT-SIG, EHT-STF, HET-LTF, and a Data frame.

L-STF, L-LTF, and L-SIG surrounded by a dotted line in FIG. 1 are configurations commonly used in the IEEE 802.11 standard (hereinafter, L-STF, L-LTF, and L-SIG will also be collectively referred to as an L-header). For example, a radio communication apparatus that is compliant with the IEEE 802.11a/b/g standard can appropriately receive an L-header inside a PPDU that is compliant with the IEEE 802.11n/ac standard. The radio communication apparatus that is compliant with the IEEE 802.11a/b/g standard can receive the PPDU that is compliant with the IEEE 802.11n/ac standard while considering it to be a PPDU that is compliant with the IEEE 802.11a/b/g standard.

Note that, because the radio communication apparatus that is compliant with the IEEE 802.11a/b/g standard cannot demodulate the PPDU that is compliant with the IEEE 802.11n/ac standard following the L-header, it is not possible to demodulate information related to a Transmitter Address (TA), a Receiver Address (RA), and a Duration/ID field used for configuring the NAV.

As a method for the radio communication apparatus that is compliant with the IEEE 802.11a/b/g standard to appropriately configure the NAV (or perform a receiving operation for a prescribed period), IEEE 802.11 defines a method of inserting Duration information into the L-SIG. Information related to a transmission speed in the L-SIG (a RATE field, an L-RATE field, an L-RATE, an L_DATARATE, and an L_DATARATE field), information related to a transmission period (a LENGTH field, an L-LENGTH field, and an L-LENGTH) are used by the radio communication apparatus that is compliant with the IEEE 802.11a/b/g standard to appropriately configure the NAV.

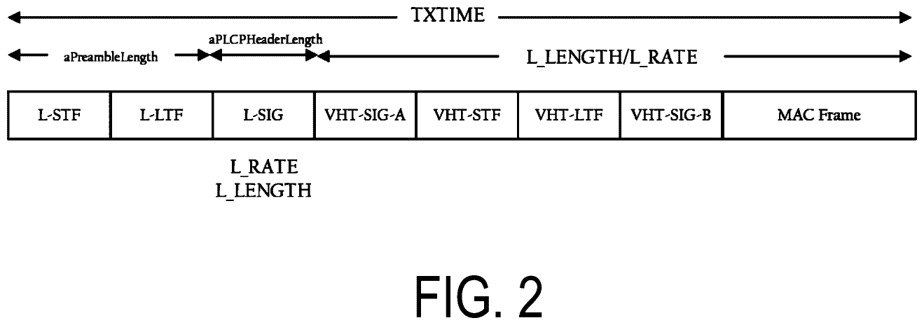

FIG. 2 is a diagram illustrating an example of a method of Duration information inserted into the L-SIG. Although a PPDU configuration that is compliant with the IEEE 802.11ac standard is illustrated as an example in FIG. 2, the PPDU configuration is not limited thereto. A PPDU configuration that is compliant with the IEEE 802.11n standard and a PPDU configuration that is compliant with the IEEE 802.11ax standard may be employed. TXTIME includes information related to the length of the PPDU, aPreambleLength includes information related to the length of a preamble (L-STF+L-LTF), and aPLCPHeaderLength includes information related to the length of a PLCP header (L-SIG). L_LENGTH is calculated based on Signal Extension that is a virtual period configured for compatibility with the IEEE 802.11 standard, Nops related to L-RATE, aSymbolLength that is information related to one symbol (a symbol, an OFDM symbol, or the like), aPLCPServiceLength indicating the number of bits included in PLCP Service field, and aPLCPConvolutionalTailLength indicating the number of tail bits of a convolution code. The radio communication apparatus can calculate L_LENGTH and insert L_LENGTH into L-SIG. The radio communication apparatus can calculate L-SIG Duration. L-SIG Duration indicates information related to a PPDU including L_LENGTH and information related to a period that is the sum of periods of Ack and SIFS expected to be transmitted by the destination radio communication apparatus in response to the PPDU.

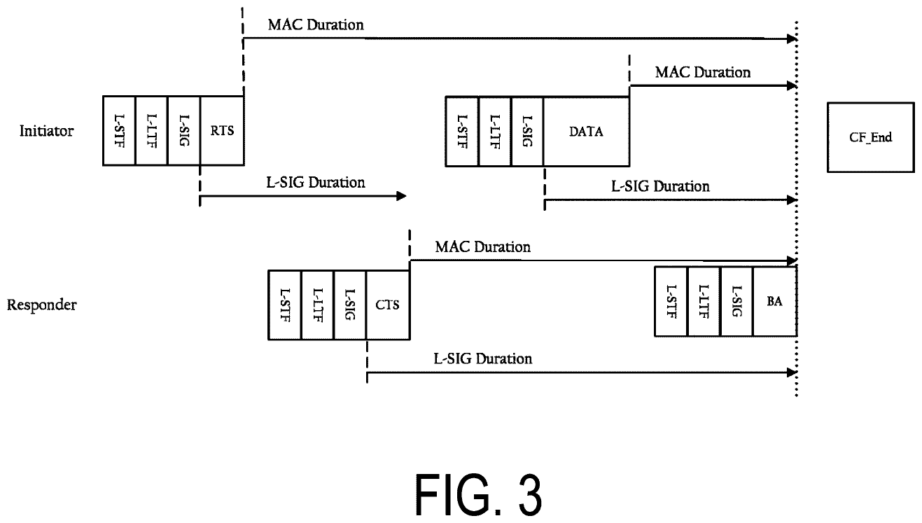

FIG. 3 is a diagram illustrating an example of L-SIG Duration in L-SIG TXOP Protection. DATA (a frame, a payload, data, and the like) include a part of or both the MAC frame and the PLCP header. BA is Block Ack or Ack. The PPDU includes L-STF, L-LTF, and L-SIG and can further include any one or more of DATA, BA, RTS, and CTS. Although L-SIG TXOP Protection using RTS/CTS is illustrated in the example illustrated in FIG. 3, CTS-to-Self may be used. Here, MAC Duration is a period indicated by a value of Duration/ID field. Initiator can transmit a CF_End frame for notifying an end of the L-SIG TXOP Protection period.

Next, a method of identifying a BSS from a frame received by a radio communication apparatus will be described. In order for the radio communication apparatus to identify the BSS from the received frame, the radio communication apparatus that transmits a PPDU preferably inserts information (BSS color, BSS identification information, a value unique to the BSS) for identifying the BSS into the PPDU. Information indicating the BSS color can be stated in HE-SIG-A.

The radio communication apparatus can transmit L-SIG multiple times (L-SIG Repetition). For example, demodulation accuracy of L-SIG is improved by the radio communication apparatus on the recipient receiving L-SIG transmitted multiple times by using Maximum Ratio Combining (MRC). Moreover, in a case that reception of L-SIG has properly been completed using MRC, the radio communication apparatus can interpret the PPDU including the L-SIG as a PPDU that is compliant with the IEEE 802.11ax standard.

Even during the operation of receiving the PPDU, the radio communication apparatus can perform an operation of receiving a part of a PPDU other than the PPDU (such as a preamble, L-STF, L-LTF, and a PLCP header defined by IEEE 802.11, for example) (also referred to as a dual-reception operation). In a case that, during the operation of receiving the PPDU, a part of a PPDU other than the PPDU is detected, the radio communication apparatus can update a part or an entirety of information related to a destination address, a source address, the PPDU, or a DATA period.

Ack and BA can also be referred to as a response (response frame). A probe response, an authentication response, and a connectivity response can also be referred to as a response.

### 1. First Embodiment

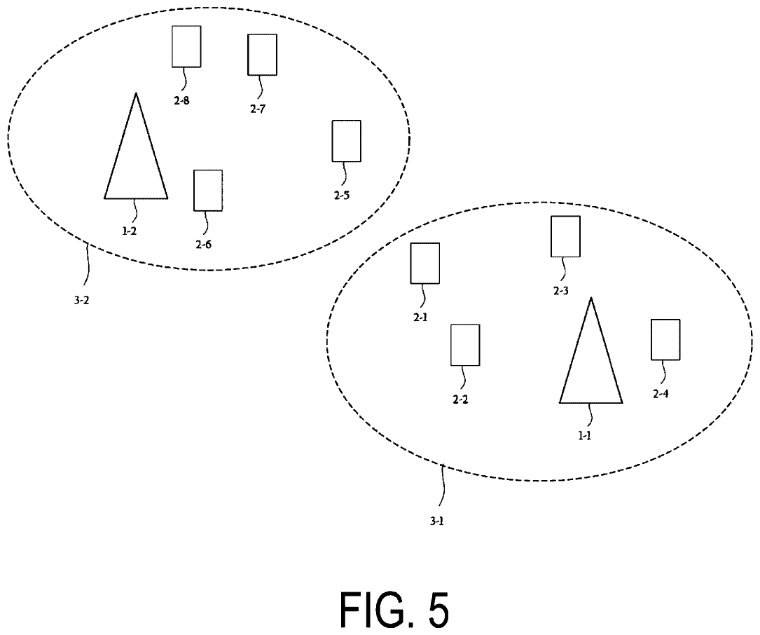

FIG. 5 is a diagram illustrating an example of a radio communication system according to the present embodiment. A radio communication system 3-1 includes a radio communication apparatus 1-1 and radio communication apparatuses 2-1 to 2-4. Note that the radio communication apparatus 1-1 will also be referred to as a base station apparatus 1-1, and the radio communication apparatuses 2-1 to 2-4 will also be referred to as terminal apparatuses 2-1 to 2-4. The radio communication apparatuses 2-1 to 2-4 and the terminal apparatuses 2-1 to 2-4 will also be referred to as a radio communication apparatus 2A and a terminal apparatus 2A, respectively, as apparatuses connected to the radio communication apparatus 1-1. The radio communication apparatus 1-1 and the radio communication apparatus 2A are wirelessly connected and are in a state in which they can transmit and/or receive PPDUs to and from each other. The radio communication system according to the present embodiment includes a radio communication system 3-2 in addition to the radio communication system 3-1. The radio communication system 3-2 includes a radio communication apparatus 1-2 and radio communication apparatuses 2-5 to 2-8. Note that the radio communication apparatus 1-2 will also be referred to as a base station apparatus 1-2 and the radio communication apparatuses 2-5 to 2-8 will also be referred to as terminal apparatuses 2-5 to 2-8. The radio communication apparatuses 2-5 to 2-8 and the terminal apparatuses 2-5 to 2-8 will also be referred to as a radio communication apparatus 2B and a terminal apparatus 2B, respectively, as apparatuses connected to the radio communication apparatus 1-2. Although the radio communication system 3-1 and the radio communication system 3-2 form different BSSs, this does not necessarily mean that Extended Service Sets (ESSs) are different. The ESSs indicate service sets forming a Local Area Network (LAN). In other words, radio communication apparatuses belonging to the same ESS can be considered to be belonging to the same network from a higher layer. Note that each of the radio communication systems 3-1 and 3-2 can further include multiple radio communication apparatuses.

In FIG. 5, it is assumed that signals transmitted by the radio communication apparatus 2A reach the radio transmitting apparatus 1-1 and the radio communication apparatus 2B while the signals do not reach the radio communication apparatus 1-2 in the following description. In other words, in a case that the radio communication apparatus 2A transmits a signal using a certain channel, the radio communication apparatus 1-1 and the radio communication apparatus 2B determine that the channel is in the busy state while the radio communication apparatus 1-2 determines that the channel is in an idle state. It is assumed that signals transmitted by the radio communication apparatus 2B reach the radio communication apparatus 1-2 and the radio communication apparatus 2A while the signals do not reach the radio communication apparatus 1-1. In other words, in a case that the radio communication apparatus 2B transmits a signal using a certain channel, the radio communication apparatus 1-2 and the radio communication apparatus 2A determine that the channel is in the busy state while the radio communication apparatus 1-1 determines that the channel is in the idle state.

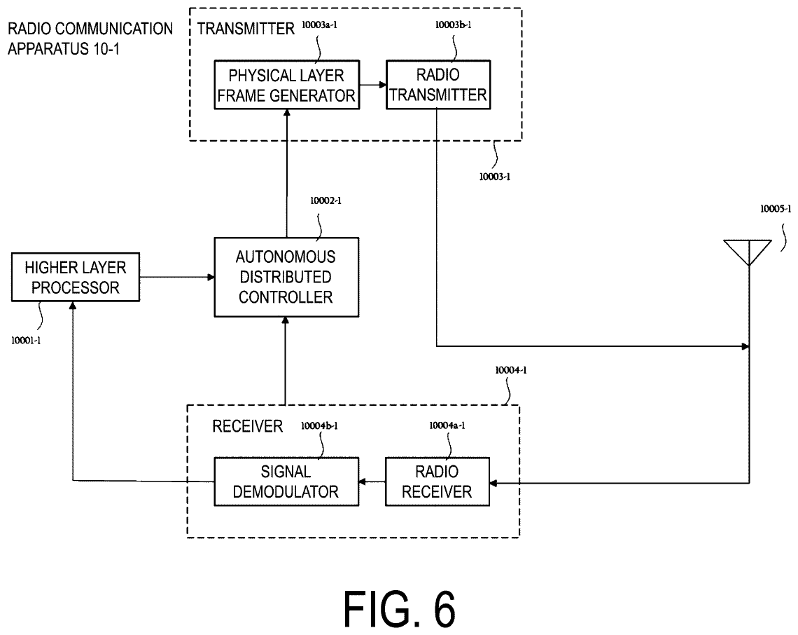

FIG. 6 is a diagram illustrating an example of an apparatus configuration of a radio communication apparatuses 1-1, 1-2, 2A, and 2B (hereinafter, collectively referred to as a radio communication apparatus 10-1 or a station apparatus 10-1 or also simply referred to as a station apparatus). The radio communication apparatus 10-1 includes a higher layer processor (higher layer processing step) 10001-1, an autonomous distributed controller (autonomous distributed control step) 10002-1, a transmitter (transmission step) 10003-1, a receiver (reception step) 10004-1, and an antenna unit 10005-1.

The higher layer processor 10001-1 is connected with another network to be able to notify the autonomous distributed controller 10002-1 of information related to a traffic. The information related to the traffic may be, for example, information destined for other radio communication apparatuses, or may be control information included in the management frame or control frame.

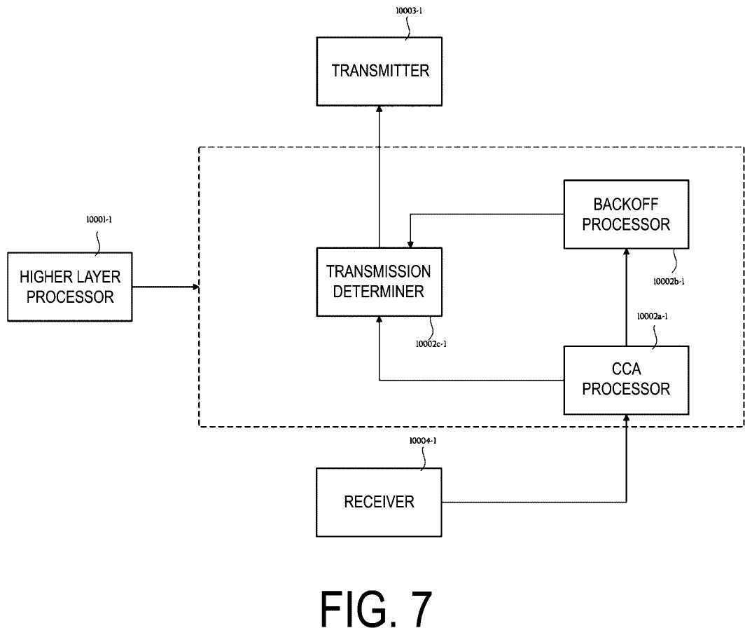

FIG. 7 is a diagram illustrating an example of an apparatus configuration of the autonomous distributed controller 10002-1. The autonomous distributed controller 10002-1 includes a CCA processor (CCA step) 10002a-1, a backoff processor (backoff step) 10002b-1, and a transmission determiner (transmission determination step) 10002c-1.

The CCA processor 10002a-1 can perform determination of a state of a radio resource (including determination between busy and idle) by using either one of or both information related to reception signal power received via the radio resource and information related to the reception signal (including information after decoding) notified from the receiver. The CCA processor 10002a-1 can notify the backoff processor 10002b-1 and the transmission determiner 10002c-1 of the state determination information of the radio resource.

The backoff processor 10002b-1 can perform backoff by using the state determination information of the radio resource. The backoff processor 10002b-1 generates CW and includes a counting-down function. For example, it is possible to perform counting-down of CW in a case that the state determination information of the radio resource indicates idle, and it is possible to stop the counting-down of CW in a case that the state determination information of the radio resource indicates busy. The backoff processor 10002b-1 can notify the transmission determiner 10002c-1 of the value of CW.

The transmission determiner 10002c-1 performs transmission determination by using either one of or both the state determination information of the radio resource and the value of CW. For example, it is possible to notify the transmitter 10003-1 of transmission determination information in a case that the state determination information of the radio resource indicates idle and the value of CW is zero. It is possible to notify the transmitter 10003-1 of the transmission determination information in a case that the state determination information of the radio resource indicates idle.

The transmitter 10003-1 includes a physical layer frame generator (physical layer frame generation step) 10003a-1 and a radio transmitter (radio transmission step) 10003b-1. The physical layer frame generator 10003a-1 includes a function of generating a physical layer frame (PPDU) based on the transmission determination information notified from the transmission determiner 10002c-1. The physical layer frame generator 10003a-1 performs error correction coding, modulation, precoding filter multiplication, and the like on the transmission frame transmitted from the higher layer. The physical layer frame generator 10003a-1 notifies the radio transmitter 10003b-1 of the generated physical layer frame.

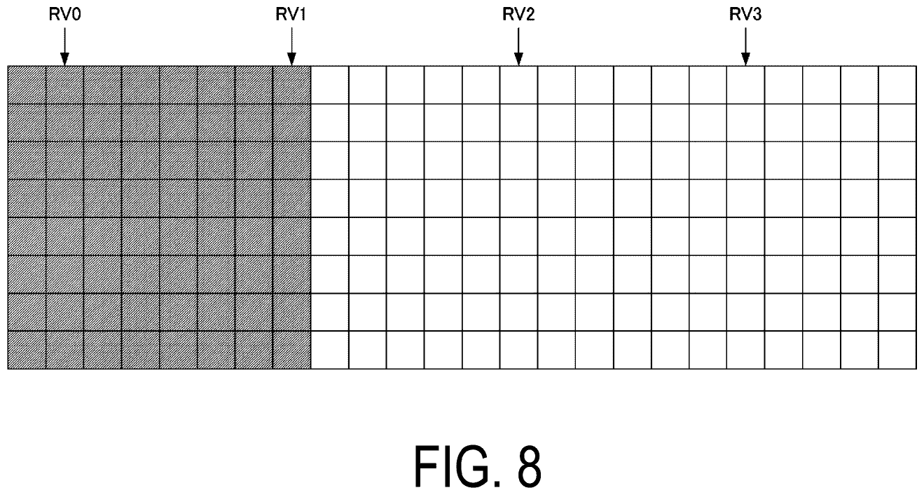

FIG. 8 is a diagram illustrating an example of error correction coding by the physical frame generator according to the present embodiment. As illustrated in FIG. 8, an information bit (systematic bit) sequence is mapped in the hatched region and a redundancy (parity) bit sequence is mapped in the white region. For each of the information bit and the redundancy bit, a bit interleaver is appropriately applied. The physical frame generator can read a necessary number of bits as a start position determined for the mapped bit sequence in accordance with a value of Redundancy Version (RV). It is possible to achieve a flexible change in coding rate, that is puncturing, through adjustment of the number of bits. Note that although a total of four RVs are illustrated in FIG. 8, the number of options for RV is not limited to a specific value in the error correction coding according to the present embodiment. The position of the RV has to be shared among the station apparatuses.

The physical layer frame generator performs error correction coding for the information bits transferred from the MAC layer, but a unit for error correction coding (coding block length) is not limited to anything. For example, the physical layer frame generator may split the information bit sequence transferred from the MAC layer into information bit sequences of a prescribed length, and perform error correction coding on the respective sequences to configure multiple coding blocks. Note that dummy bits can be inserted into the information bit sequence transferred from the MAC layer in configuring the coding block.

The frame generated by the physical layer frame generator 10003a-1 includes control information. The control information includes information indicating data destined for each radio communication apparatus is mapped to which RU (here, the RU includes both frequency resources and spatial resources). The frame generated by the physical layer frame generator 10003a-1 includes a trigger frame for providing an indication of frame transmission to the radio communication apparatus being a destination terminal. The trigger frame includes information indicating the RU used in a case that the radio communication apparatus that has received the indication of the frame transmission transmits the frame.

The radio transmitter 10003b-1 converts the physical layer frame generated by the physical layer frame generator 10003a-1 into a signal in a Radio Frequency (RF) band to generate a radio frequency signal. Processing performed by the radio transmitter 10003b-1 includes digital-to-analog conversion, filtering, frequency conversion from a baseband to an RF band, and the like.

The receiver 10004-1 includes a radio receiver (radio receiving step) 10004a-1 and a signal demodulator (signal demodulation step) 10004b-1. The receiver 10004-1 generates information related to reception signal power from the signal in the RF band received by the antenna unit 10005-1. The receiver 10004-1 can notify the CCA processor 10002a-1 of the information related to the reception signal power and the information related to the reception signal.

The radio receiver 10004a-1 includes a function of converting the signal in the RF band received by the antenna unit 10005-1 into a baseband signal and generating a physical layer signal (for example, a physical layer frame). Processing performed by the radio receiver 10004a-1 includes frequency conversion processing from the RF band to the baseband, filtering, and analog-to-digital conversion.

The signal demodulator 10004b-1 includes a function of demodulating the physical layer signal generated by the radio receiver 10004a-1. Processing performed by the signal demodulator 10004b-1 includes channel equalization, demapping, error correction decoding, and the like. The signal demodulator 10004b-1 can extract, from the physical layer signal, information included in the physical layer header, information included in the MAC header, and information included in the transmission frame, for example. The signal demodulator 10004b-1 can notify the higher layer processor 10001-1 of the extracted information. Note that the signal demodulator 10004b-1 can extract any one or all of information included in the physical layer header, information included in the MAC header, and information included in the transmission frame.

The antenna unit 10005-1 includes a function of transmitting the radio frequency signal generated by the radio transmitter 10003b-1 to a radio space toward a radio apparatus 0-1. The antenna unit 10005-1 includes a function of receiving the radio frequency signal transmitted from the radio apparatus 0-1.

The radio communication apparatus 10-1 can cause radio communication apparatuses in the surroundings of the radio communication apparatus 10-1 to configure NAV corresponding to a period during which the radio communication apparatus 10-1 uses a radio medium by stating information indicating the period in the PHY header or the MAC header of the frame to be transmitted. For example, the radio communication apparatus 10-1 can state the information indicating the period in a Duration/ID field or a Length field in the frame to be transmitted. The NAV period configured to radio communication apparatuses in the surroundings of the radio communication apparatus 10-1 will be referred to as a TXOP period (or simply TXOP) acquired by the radio communication apparatus 10-1. The radio communication apparatus 10-1 that has acquired the TXOP will be referred to as a TXOP holder. The frame type of frame to be transmitted by the radio communication apparatus 10-1 to acquire TXOP is not limited to any frame type, and the frame may be a control frame (for example, an RTS frame or a CTS-to-self frame) or may be a data frame.

The radio communication apparatus 10-1 that is a TXOP holder can transmit the frame to radio communication apparatuses other than the radio communication apparatus 10-1 during the TXOP. In a case that the radio communication apparatus 1-1 is a TXOP holder, the radio communication apparatus 1-1 can transmit a frame to the radio communication apparatus 2A during the TXOP period. The radio communication apparatus 1-1 can provide an indication of frame transmission destined to the radio communication apparatus 1-1 to the radio communication apparatus 2A during the TXOP period. The radio communication apparatus 1-1 can transmit, to the radio communication apparatus 2A, a trigger frame including information for providing the indication of the frame transmission destined to the radio communication apparatus 1-1 during the TXOP period.

The radio communication apparatus 1-1 may ensure the TXOP for the entire communication band (an Operation bandwidth, for example) that may be used for the frame transmission, or may ensure the TXOP for a specific communication Band such as a communication band actually used to transmit the frame (a Transmission bandwidth, for example).

The radio communication apparatus to which the radio communication apparatus 1-1 provides an indication of frame transmission in the acquired TXOP period is not necessarily limited to radio communication apparatuses connected to the radio communication apparatus 1-1. For example, the radio communication apparatus can provide an indication for transmitting frames to radio communication apparatuses that are not connected to the former radio communication apparatus in order to cause the radio communication apparatuses in the surroundings of the former radio communication apparatus to transmit management frames such as a Reassociation frame or control frames such as an RTS/CTS frame.

Further, a description is also given of the TXOP in the EDCA that is a data transmission method different from the DCF. The IEEE 802.11e standard relates to the EDCA, and is defined for the TXOP from the perspective of QoS (Quality of Service) assurance for various services such as video transmission or VoIP. The services are briefly classified into four access categories of VO (VOicc), VI (VIdeo), BE (BestEffort), and BK (Back ground). Typically, the order is of VO, VI, BE, and BK in descending order of the priority. Each of the access categories has parameters of CWmin as a CW minimum value, CWmax as a maximum value, AIFS (Arbitration IFS) as a type of IFS, and TXOP limit as an upper limit value of the transmission opportunity, which are configured to give a height difference of the priority. For example, CWmin, CWmax, and AIFS for the VO with the highest priority intended for voice transmission can be configured to have a relatively small values in comparison to those of other access categories, so that data transmission more prioritized than other access categories can be performed. For example, for the VI, where the amount of transmission data is relatively large due to video transmission, the TXOP limit can be configured to be larger, so that the transmission opportunity can be longer than other access categories. In this manner, the values of the four parameters for each of the access categories are adjusted for purpose of the QoS assurance in accordance with various services.

In the present embodiment, the signal demodulator of the station apparatus can perform decoding processing and perform error detection on a received signal in the physical layer. Here, the decoding processing includes decoding processing on an error correction code applied to the received signal. Here, the error detection includes error detection using an error detection code that has been pre-applied to the received signal (e.g., a cyclic redundancy check (CRC) code), and error detection using an error correction code originally having an error detection function (e.g., a low density parity check code (LDPC). The decoding processing in the physical layer can be applied per coding block.

The higher layer processor transfers a result of decoding the physical layer in the signal demodulator to the MAC layer. In the MAC layer, the signal for the MAC layer is restored from the transferred result of decoding the physical layer. Then, in the MAC layer, error detection is performed to determine whether the signal for the MAC layer transmitted by the transmission source station apparatus of the reception frame is correctly restored.

The radio communication apparatus according to the present embodiment can perform a procedure for establishing multiple connections (multi-link) (multi-link establishment request, multi-link establishment response) to establish and maintain the multi-link. Here, “maintaining the multi-link” means that a frame can be transmitted and/or received based on a prescribed configuration for the multi-link. A procedure for changing a configuration of the multi-link (multi-link change request, multi-link change response) can also be performed while the multi-link being maintained. A procedure for releasing the multi-link (multi-link release request, multi-link release response) can also be performed to release the multi-link.

The number of links constituting the multi-link is any number of two or more. A carrier frequency of the link may vary depending on the regulations of each country, including a 2.4 GHz band, a 5 GHz band, and additionally a 6 GHz band, a 60 GHz band, and the like.

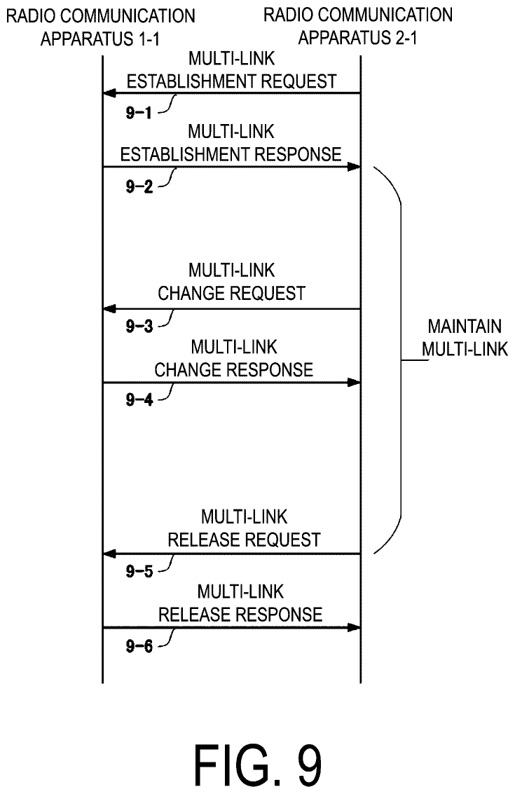

FIG. 9 illustrates an overview of a procedure related to the multi-link according to the present embodiment, using a radio communication apparatus 1-1 and a radio communication apparatus 2-1 as examples of the radio communication apparatus. In this case, the radio communication apparatus 2-1 that transmits a multi-link establishment request (9-1) is called a multi-link initiator and the radio communication apparatus 2-1 transmits the multi-link establishment request (9-1) to the radio communication apparatus 1-1. The multi-link establishment request may include multi-link capability information of the radio communication apparatus 2-1, multi-link operation mode information for requesting establishment, and the like. Note that the multi-link initiator may be the radio communication apparatus 1-1 rather than the radio communication apparatus 2-1.

The radio communication apparatus 1-1 receiving the multi-link establishment request transmits a multi-link establishment response (9-2) to the radio communication apparatus 2-1. The multi-link establishment response may include multi-link capability information of the radio communication apparatus 1-1, establishment state information indicating whether the multi-link establishment is successful, a multi-link ID (ID: Identity, identifier) used for identifying the multi-link, the multi-link operation mode information, and the like. The multi-link ID may be a TID (Traffic ID), or may be a value based on the TID. The multi-link operation mode information included in the multi-link establishment response may be determined ultimately based on the multi-link operation mode included in the multi-link establishment request received from the radio communication apparatus 2-1 and the multi-link operation mode the radio communication apparatus 1-1 can provide. In a case that the establishment state information indicates successful, a multi-link according to the multi-link operation mode information included in the multi-link establishment response is established. In a case that the establishment state information indicates failure, a multi-link cannot be established.

The multi-link capability information may include information such as channel information the radio communication apparatus 1-1 can use (frequency, bandwidth, and the like), whether to support STR (Simultaneously Transmission and Reception, simultaneous transmission and/or reception simultaneously performing frame transmission and frame reception), whether to support frame synchronization, whether to support multi-link aggregation, whether to support multi-link switch, and multi-link TXOP (maximum value, minimum value, and the like). The multi-link operation mode information may include channel information of each link constituting the multi-link (frequency, bandwidth, and the like), multi-link TXOP limit, multi-link aggregation, multi-link switch, frame synchronization, frame asynchronization, STR, non-STR, and the like.

The multi-link TXOP is a parameter that effectively acts on only the MLO. The multi-link TXOP with a parameter included in the multi-link capability information may be provided with some fields to include information such as the maximum value (a value limited by the regulations of each country, and the like), a recommended value, and the minimum value (a value required to be minimally reserved for service assurance of the multi-link initiator, and the like) the radio communication apparatus 1-1 supports. In a case that the value of the multi-link TXOP included in the multi-link capability information is configured to a special value such as 0 or NULL, the multi-link TXOP may be invalid, and only the TXOP according to the techniques of the related art may be reserved.

The multi-link TXOP limit included in the multi-link operation mode information in the multi-link establishment response has a value stored that is determined by negotiation between the radio communication apparatus 1-1 and the radio communication apparatus 2-1. Specifically, the multi-link TXOP limit is determined that satisfies conditions of both the value of the multi-link TXOP included in the multi-link capability information of the radio communication apparatus 2-1 and the multi-link TXOP included in the multi-link capability information of the radio communication apparatus 1-1. The radio communication apparatus 1-1 and the radio communication apparatus 2-1 that establish the multi-link, in a case of acquiring a transmission right on the radio medium through carrier sense or the like, can occupy the radio medium for the determined multi-link TXOP section in a range not exceeding the multi-link TXOP limit, and can transmit one or more PPDU frames.

The multi-link TXOP of the established multi-link is not known to other than the radio communication apparatus 1-1 and the radio communication apparatus 2-1. However, as described above, the radio communication apparatus can cause radio communication apparatuses in the surroundings of the radio communication apparatus to configure NAV corresponding to a period during which the radio communication apparatus uses a radio medium by describing information indicating the period in the PHY header or the MAC header of each PPDU frame to be transmitted.

The multi-link TXOP limit is a parameter separate from the TXOP limit defined in the IEEE 802.11e standard. During the negotiation between the radio communication apparatus 1-1 and the radio communication apparatus 2-1 described above, the multi-link TXOP limit may be determined in consideration of the TXOP limit defined in the IEEE 802.11e standard. Specifically, the multi-link TXOP limit is determined that satisfies conditions of the value of the multi-link TXOP included in the multi-link capability information of the radio communication apparatus 2-1, the multi-link TXOP included in the multi-link capability information of the radio communication apparatus 1-1, and the TXOP limit configured according to the IEEE 802.11c standard. Alternatively, the values of the multi-link TXOP included in the multi-link capability information or the multi-link TXOP limit included in the multi-link operation mode information may be configured to special values such as 0 or NULL to be invalidated, and the TXOP limit configured according to the IEEE 802.11e standard may be validated. This makes it possible also to configure the multi-link TXOP limit preferable for each of the access categories of VO, VI, BK, and BE.

Note that the number of multi-links established between the radio communication apparatus 1-1 and the radio communication apparatus 2-1 is not limited to one, and a plurality of multi-links can be established. Each multi-link can also be identified by the multi-link ID.

The established multi-link is then maintained. In a case that the multi-link operation mode or the like is changed, a procedure of a multi-link change request (9-3) can be performed while maintaining the multi-link connection. A time length of the multi-link TXOP limit can also be changed by the multi-link change request. FIG. 9 illustrates an example in which the radio communication apparatus 2-1 as the multi-link initiator transmits the multi-link change request to the radio communication apparatus 1-1, and the radio communication apparatus 1-1 returns a multi-link change response (9-4) to the radio communication apparatus 2-1, but conversely, the radio communication apparatus 1-1 that is not a multi-link initiator may transmit the multi-link change request and the radio communication apparatus 2-1 may return the multi-link change response. The multi-link change response includes the change state information indicating whether the change is accepted, which makes it possible to know whether the change in the operation mode or the like is successful or failure. Note that the multi-link change request configured to include the multi-link ID can indicate the multi-link to be changed in the operation mode.

A multi-link release request (9-5) can be transmitted to release the multi-link. The multi-link release request configured to include the multi-link ID can indicate the multi-link to be released. The multi-link release request configured not to include the multi-link ID or the multi-link ID configured to be a special value such as NULL may cause a plurality of multi-links established between the radio communication apparatus 1-1 and the radio communication apparatus 2-1 to be released at once. FIG. 9 illustrates an example in which the radio communication apparatus 2-1 as the multi-link initiator transmits the multi-link release request to the radio communication apparatus 1-1, and the radio communication apparatus 1-1 returns a multi-link release response (9-6) to the radio communication apparatus 2-1, but conversely, the radio communication apparatus 1-1 that is not a multi-link initiator may transmit the multi-link release request. The multi-link release response may include release state information indicating whether the release is accepted.

The multi-link establishment request may be included in a frame for the connection (Association) procedure or a reconnection (Reassociation) procedure, or may be a procedure using a dedicated frame at a timing as necessary after the connection (Association) procedure or the reconnection (Reassociation) procedure. The multi-link release request may be included in a disconnection (Disassociation or Deauthentication) procedure, or may be requested separately at a timing as necessary before the disconnection (Disassociation or Deauthentication) procedure.

The information related to the multi-link such as the multi-link capability information and the multi-link operation mode may be included in a management frame transmitted by the radio communication apparatus 1-1 such as Beacon and ProbeResponse. The information related to the multi-link such as the multi-link capability information and the multi-link operation mode may be handled as Management Information Base (MIB) information.

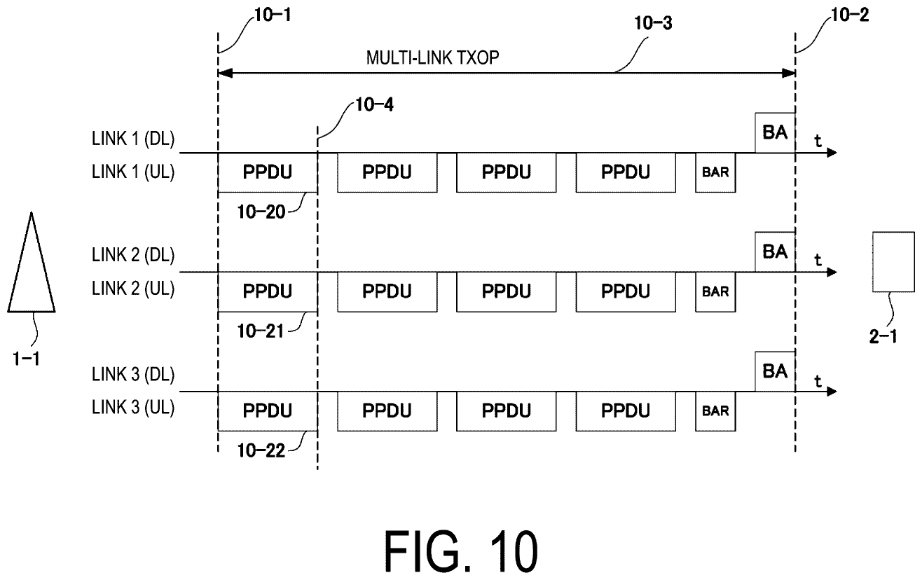

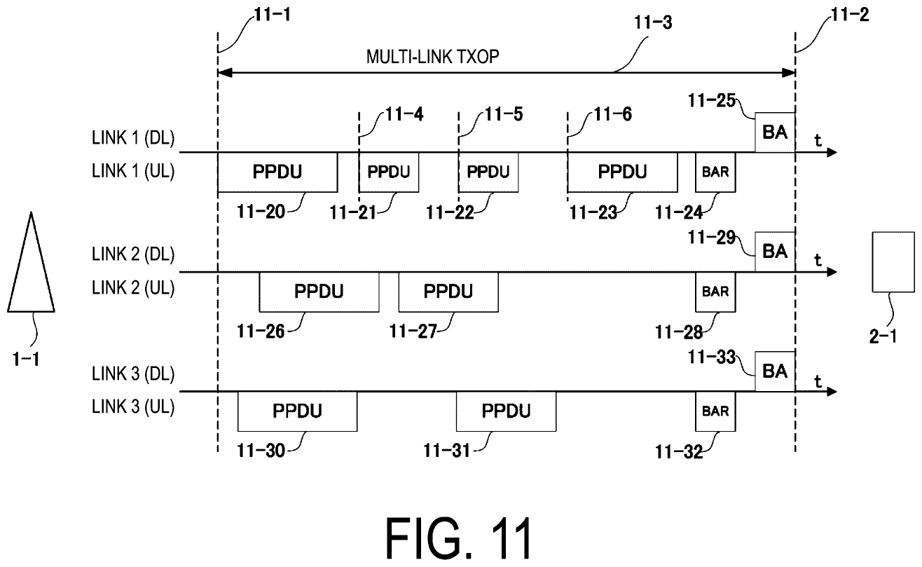

Here, using FIG. 10 and FIG. 11, a frame synchronization mode and a frame asynchronization mode included in the operation mode will be described. The radio communication apparatus 2-1 according to the present embodiment establishes a multi-link with the radio communication apparatus 1-1. FIG. 10 illustrates an example of a multi-link including three links (link 1, link 2, link 3), where respective links are different in carrier frequency, e.g., the link 1 operates in a 2.4 GHz band frequency, the link 2 operates in a 5 GHz band frequency of W52 (5.15 to 5.25 GHZ), and the link 3 operates in 5 GHz band frequency of W53 (5.25 to 5.35 GHZ). FIG. 10 illustrates a state in which the start times and end times of respective PPDUs (10-20, 10-21, and 10-22 in an example) transmitted are aligned among the all links (link 1, link 2, and link 3), and is an example of a PPDU transmission in a state of frame synchronization in a time axis in a case that time lengths of the PPDUs are the same. The above example is not a limitation, and in a case that the time lengths of the PPDUs are different from each other, the transmission in a state where only the start times (left edges) or the end times (right edges) are aligned is also an example of the frame synchronization transmission. Time adjustment with high accuracy is required for frame synchronization, and thus the difficulty is high. As illustrated in FIG. 11, a method of transmission in a state where the start times (left edges), the end times (right edges), or the start times and end times of the respective transmitted PPDUs are not aligned among the all links is the frame asynchronization mode. The frame transmission timing in each link is not restricted and the time adjustment is not required, so this method can be said to be a method easy to implement.

The frame synchronization mode and the frame asynchronization mode are used depending on the use case. For example, in a case of multi-link transmission of only data related to one application in the higher layer, transmission in the synchronization mode may be preferred. On the other hand, in a case of multi-link transmission of data related to two or more different applications in the higher layer, transmission in the frame asynchronization mode may be preferred in order to suppress latency of each application because the timing of data generation may be varied.

Even in a case that the amounts of data before coding transmitted in the respective links are the same, the number of MPDUs included in the A-MPDU increases due the reduced coding rate on the link with poor radio conditions, and the PPDU length may increase. In a case that the frame synchronization transmission is attempted, it is assumed that the PPDUs having different time lengths occurring in accordance with the radio conditions that changes by the minute on the respective links would be handled, and accordingly calculations for the time adjustment with high accuracy may be required in each handling. The frame asynchronization mode, which does not require the time adjustment, is simple, whereas the frame synchronization mode is high in the difficulty of implementation. It is also conceivable that the frame synchronization mode and the frame asynchronization mode are used depending on the use case or the like in addition to the capability of the radio communication apparatus.

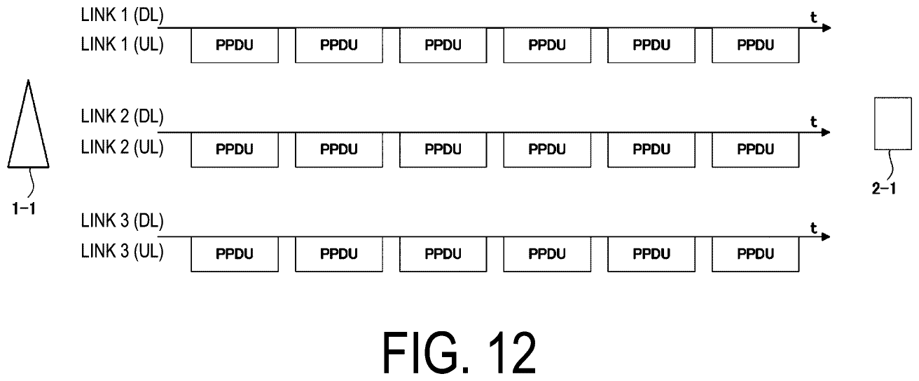

Next, the multi-link aggregation mode and the multi-link switch mode included in the operation mode will be described. FIG. 12 illustrates an overview diagram of a frame transmission example in the multi-link aggregation mode, where only a PPDU corresponding to a data frame is depicted, and a response frame (ACK, BA, and the like) is omitted. The primary purpose of the multi-link aggregation mode is to increase throughput as a whole by using multiple links simultaneously to perform data transmission.

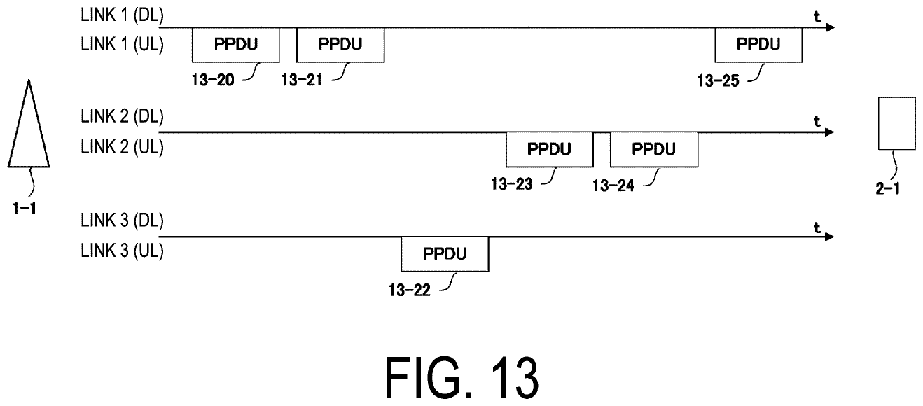

FIG. 13 illustrates an overview diagram of a frame transmission example in the multi-link switch mode, where only a PPDU corresponding to a data frame is depicted, and a response frame (ACK, BA) is omitted. The primary purpose of the multi-link switch mode is to avoid interruption of the link between the radio communication apparatuses, and is not to use multiple links simultaneously. The throughput increase is not intended, and, for example, PPDUs 13-20 and 13-21 are transmitted on the link 1, and in a case that the radio condition of the link 1 becomes worse, the communication is changed to communication on the link 3 to transmit a PPDU 13-22. In addition, in a case that the radio condition on the link 3 becomes worse, the communication is changed to communication on the link 2 to transmit PPDUs 13-23 and 13-24. In addition, in a case that the radio condition on the link 2 becomes worse, the communication is changed to communication on the link 1 to transmit a PPDU 13-25. The frame transmission and/or reception is performed in at least one link on the multi-link maintained in this manner can avoid the link interruption between the radio communication apparatuses. In a case that communication of the related art is performed in only the link 1 without using a multi-link, communication block may be made in a case that the radio condition of the link 1 becomes worse, but this problem can be avoided by the multi-link switch mode.

In this manner, the multi-link aggregation mode and the multi-link switch mode are different in their purposes. In a case that the radio communication apparatus 2-1 uses the multi-link aggregation, the radio communication apparatus 2-1 configures the multi-link aggregation in the operation mode information included in the multi-link establishment request. The radio communication apparatus 1-1 configures the multi-link aggregation in the operation mode information included in the multi-link establishment response, and in a case that the establishment state information indicates successful, the multi-link operates in the multi-link aggregation mode. Follow the same procedure in a case of establishing the multi-link in the multi-link switch mode. Follow the same procedure to establish the multi-link in other operation modes (frame synchronization, frame asynchronization, STR, non-STR, and the like).

The multi-link change request, after the multi-link establishment, configured to include the multi-link operation mode information can change the multi-link operation mode. By way of example, the operation mode may be switched from the multi-link aggregation mode to the multi-link switch mode, and conversely from the multi-link switch mode to the multi-link aggregation mode. The operation mode switching is not limited to the combination of the multi-link aggregation and the multi-link switches, and is possible between the respective modes included in the operation mode (multi-link aggregation, multi-link switch, frame synchronization, frame asynchronization, STR, non-STR, and the like). Note that the value of the other information included in the operation mode, the channel information (frequency, bandwidth, and the like), and the multi-link TXOP limit can also be changed.

A plurality of multi-links may be configured, and different operation modes may be assigned for each multi-link. For example, in a case that two multi-links can be established, these two multi-links include a link of a 2.4 GHz frequency and a link of a 5 GHz frequency, while these two multi-links may operate in different operation modes such that the operation mode of the first multi-link is the multi-link aggregation mode and the operation mode of the second multi-link is the multi-link switch mode. Other operation methods of a plurality of multi-links are further described. For example, in a case that two multi-links can be established, a combination of the frequencies may be configured to be different such that the first multi-link includes a link of a 2.4 GHz frequency and a link of a 5 GHz frequency, and the second multi-link includes a link of a 5 GHz frequency and a link of a 60 GHz frequency. Note that the types of the multi-link operation mode assigned for each multi-link include channel information (frequency, bandwidth, and the like), multi-link TXOP limit, multi-link aggregation, multi-link switch, frame synchronization, frame asynchronization, STR, non-STR, and the like.

According to the present embodiment, by providing the method for configuring the operation mode in the multi-link establishment request procedure or the multi-link change request procedure, the operation mode can be switched depending on the use case, and the efficiency of the multi-link operation can be improved. Furthermore, the operation mode during the multi-link communication can be restricted, and the operating specifications required for the radio communication apparatus can also be minimized. For example, in a case that the frame asynchronization mode is selected, it is not necessary to have the same frame transmission timing among the links constituting the multi-link, and the calculation for the transmission timing time adjustment can be omitted. For example, in a case that the multi-link switch mode is selected, it is also possible to save power by switching only the required minimum link among the multi-links into an active state and the other links into a deactivated state.

### 2. Matters Common to All Embodiments

A program that operates in the radio communication apparatus according to the present invention is a program (a program for causing a computer to function) for controlling the CPU or the like to implement the functions of the aforementioned embodiments related to the present invention. The information handled by these apparatuses is temporarily held in a RAM at the time of processing, is then stored in various types of ROMs and HDDs, and is read by the CPU as necessary to be corrected and written. Here, a semiconductor medium (ROM, a non-volatile memory card, or the like, for example), an optical recording medium (DVD, MO, MD, CD, BD, or the like, for example), a magnetic recording medium (magnetic tape, a flexible disk, or the like, for example), and the like can be given as examples of recording media for storing the programs. In addition to implementing the functions of the aforementioned embodiments by performing loaded programs, the functions of the present invention may be implemented by the programs running cooperatively with an operating system, other application programs, or the like in accordance with indications included in those programs.

In a case of delivering these programs to market, the programs can be stored and distributed in a portable recording medium, or transferred to a server computer connected via a network such as the Internet. In this case, storage devices in the server computer are also included in the present invention. A part or an entirety of the communication apparatus in the aforementioned embodiments may be implemented as an LSI that is typically an integrated circuit. The functional blocks of the communication apparatus may be individually implemented as chips or may be partially or completely integrated into a chip. In a case that the functional blocks are integrated, an integrated circuit controller for controlling them is added.

The circuit integration technique is not limited to LSI, and the integrated circuits for the functional blocks may be realized as dedicated circuits or a multi-purpose processor. In a case that, with advances in semiconductor technology, a circuit integration technology replacing an LSI appears, it is also possible to use an integrated circuit based on the technology.

Note that the invention of the present application is not limited to the above-described embodiments. The radio communication apparatus according to the invention of the present application is not limited to the application in the mobile station apparatus, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the claims.

### INDUSTRIAL APPLICABILITY

The present invention can be preferably used in a communication apparatus and a communication method.

### REFERENCE SIGNS LIST

1-1, 1-2 Access point apparatus
2-1 to 8 Station apparatus
3-1, 3-2 Management range
10001-1 Higher layer processor
10002-1 Autonomous distributed controller
10002a-1 CCA processor
10002b-1 Backoff processor
10002c-1 Transmission determiner
10003-1 Transmitter
10003a-1 Physical layer frame generator
10003b-1 Radio transmitter
10004-1 Receiver
10004a-1 Radio receiver
10004b-1 Signal demodulator
10005-1 Antenna unit
13-20 to 13-25 PPDU

1: A station apparatus for communicating with an access point apparatus using multiple links, each of the multiple links using a different frequency, the station apparatus comprising:
a transmitter configured to transmit a first management frame; and
a receiver configured to receive a second management fame as a response to the first management frame; wherein
the first management frame includes first information indicating either a first operation mode or a second operation mode as a multi-link operation mode, the first management frame also including second information indicating a first link used by the station apparatus in the multi-link operation mode, the first link being one of the multiple links;
the first operation mode is the multi-link operation mode in which the station apparatus transmits or receives frames on one of the multiple links; and
the station apparatus operates in the first operation mode after the receiver receives the second management frame.

2: The station apparatus according to claim 1, wherein the station apparatus operates in the first operation mode, after the receiver receives the second management frame, in a case where the second management frame indicates that the station apparatus is allowed to operate in the first operation mode.

3: The station apparatus according to claim 1, wherein, before the transmitter transmits the first management frame, the transmitter transmits a third management frame, and the receiver receives a fourth management frame as a response to the third management frame and then establishes a multi-link connection using the multiple links with the access point apparatus.

4: The station apparatus according to claim 3, wherein the first management frame is different from the third management frame and the second management frame is different from the fourth management frame.

5: An access point apparatus for communicating with a station apparatus using a multiple links, each of the multiple links using a different frequency, the access point comprising:
a receiver configured to receive a first management frame; and
a transmitter configured to transmit a second management frame as a response to the first management frame; wherein
the first management frame includes first information indicating either a first operation or a second operation mode as a multi-link operation mode, the first management frame also including second information indicating a first link used by the station apparatus in the multi-link operation mode, the first link being one of the multiple links.

6: A method for a station apparatus communicating with an access point apparatus using a multiple links, each of the multiple links using a different frequency, the method comprising:
transmitting a first management frame; and
receiving a second management fame as a response to the first management frame; wherein
the first management frame includes first information indicating either a first operation mode or a second operation mode as a multi-link operation mode, the first management frame also including second information indicating a first link used by the station apparatus in the multi-link operation mode, the first link being one of the multiple links;
the first operation mode is the multi-link operation mode in which the station apparatus transmits or receives frames on one of the multiple links; and
the method further comprising operating in the first operation mode after receiving the second management frame.
